(19) United States
(12) Patent Application Publication
(10) Pub. No.: US 2025/0272445 A1
(43) Pub. Date: Aug. 28, 2025

(54) METHOD AND SYSTEM FOR SELECTING PLACEMENT OF AN ELECTRIC VEHICLE SUPPLY EQUIPMENT BASED ON WIFI VERIFICATION

(71) Applicant: Ford Global Technologies, LLC, Dearborn, MI (US)

(72) Inventors: Ryan O'Gorman, Beverly Hills, MI (US); Chandrakant Kulkarni, Canton, MI (US); Matthew Roseman, Farmington Hills, MI (US); Stuart C. Salter, White Lake, MI (US); John Robert Van Wiemeersch, Novi, MI (US)

(21) Appl. No.: 18/588,419

(22) Filed: Feb. 27, 2024

(51) Int. Cl. G06F 30/13; G01S 11/06; H04B 17/318

(52) U.S. Cl. CPC G06F 30/13; G01S 11/06; H04B 17/318

(57) ABSTRACT

A method includes estimating an inferred charge station wireless communication signal strength for a new electric vehicle supply equipment (EVSE) using signal strength data and a signal strength surrogate model. The signal strength data is indicative of signal strength of a wireless communication network measured by a measurement vehicle, where the wireless communication network is to be in communication with the new EVSE. The signal strength surrogate model is configured to define one or more signal strengths using surrogate information associating a plurality of surrogate charge stations with respective surrogate vehicles, and signal strength data associated with, at least one of the surrogate charge stations or the surrogate vehicles. The method further includes outputting an installation recommendation in response to the inferred charge station wireless communication signal strength being less than or equal to a connectivity threshold.

### TECHNICAL FIELD

The present disclosure is generally directed towards a method and/or system for selecting a location for an electric vehicle supply equipment.

### BACKGROUND

The statements in this section merely provide background information related to the present disclosure and may not constitute prior art.

Electric vehicles, such as plug-in hybrid or full electric vehicles, generally use an electric vehicle supply equipment (EVSE), which may also be referred to as an electric vehicle charge station (EVCS), to charge a battery pack within the vehicle. The charge station not only includes complex power electronics (e.g., inverters, rectifiers) to charge the vehicle, but also has sophisticated programming to control the transfer of power, which may be managed remotely. Accordingly, the EVSE may include connectivity devices to establish wireless communication with external devices/systems.

### SUMMARY

This section provides a general summary of the disclosure and is not a comprehensive disclosure of its full scope or all of its features.

In one form, the present disclosure is directed to a method including estimating an inferred charge station wireless communication signal strength for a new electric vehicle supply equipment (EVSE) using signal strength data and a signal strength surrogate model. The signal strength data is indicative of signal strength of a wireless communication network measured by a measurement vehicle, where the wireless communication network is to be in communication with the new EVSE. The signal strength surrogate model is configured to define one or more signal strengths using surrogate information associating a plurality of surrogate charge stations with respective surrogate vehicles, and signal strength data associated with, at least one of the surrogate charge stations or the surrogate vehicles. The method further includes outputting an installation recommendation in response to the inferred charge station wireless communication signal strength being less than or equal to a connectivity threshold.

In one form, the present disclosure is directed to a system including one or more computing devices configured to estimate an inferred charge station wireless communication signal strength for a new electric vehicle charge station (EVSE) using signal strength data and a signal strength surrogate model. The signal strength data is indicative of signal strength of a wireless communication network measured by a measurement vehicle, wherein the wireless communication network is to be in communication with the new EVSE. The signal strength surrogate model is configured to define one or more signal strengths using surrogate information associating a plurality of surrogate charge stations with respective surrogate vehicles, and signal strength data associated with, at least one of the surrogate charge stations or the surrogate vehicles. The one or more computing devices is further configured to output an installation recommendation in response to the inferred charge station wireless communication signal strength being less than or equal to a connectivity threshold.

In one form, the present disclosure is directed to a method including estimating an inferred charge station wireless communication signal strength for a new electric vehicle supply equipment (EVSE) using signal strength data and a signal strength surrogate model. The signal strength data is indicative of a plurality of signal strength measurements of a wireless communication network measured by a measurement vehicle, where the wireless communication network is to be in communication with the new EVSE. The signal strength surrogate model is configured to define one or more signal strengths using surrogate information associating a plurality of surrogate charge stations with respective surrogate vehicles, and signal strength data associated with, at least one of the surrogate charge stations or the surrogate vehicles. The method further includes outputting a message confirming installation location for the new EVSE in response to the inferred charge station wireless communication signal strength being greater than a connectivity threshold, and outputting an installation recommendation in response to the inferred charge station wireless communication signal strength being less than or equal to the connectivity threshold, the installation recommendation including at least one of recommending a different installation location for the new EVSE or one or more connectivity enhancement to increase signal strength

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a desired area for installing a charge station in accordance with the present disclosure; and

FIG. 2 is a flowchart of a charge station signal strength routine for estimating an inferred charge station signal strength in accordance with the present disclosure.

The drawings described herein are for illustration purposes only and are not intended to limit the scope of the present disclosure in any way.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the following, an EVSE may be referred to as the EVCS or simply, a charge station (CS).

A charge station may use a local Wi-Fi network to communicate with external systems/devices, and, in some instances, the location of the charge station may have a low signal strength resulting in connectivity issues at the charge station. For example, if the charge station is for occupants of a building, such as a house, a Wi-Fi router for the local Wi-Fi network may be far enough from the charge station, such that the signal strength at the charge station is substantially degraded when compared to the signal strength within the building.

Prior to installing the charge station, the accessibility of the local Wi-Fi network at one or more potential installation locations (PIL) of the charge station can be assessed by measuring a signal strength of the local Wi-Fi network. To do this, a portable computing device having a software application for measuring signal strength can be used to measure the local Wi-Fi network, however, an antenna in the device is likely not the same as an antenna of the charge station, and thus, the measurement may not be representative of what the charge station experiences. Furthermore, the local Wi-Fi network can provide varying signal strength due to various factors, such as but not limited to, weather conditions, condition of cable/satellite/cellular infrastructure supporting the local Wi-Fi network, other wireless communication networks (e.g., BLUETOOTH and other Wi-Fi hot spots in the area), and/or number of devices on the local Wi-Fi network. Accordingly, a single signal strength measurement may not be sufficient to ascertain the signal strength at the potential installation location.

In one form, the present disclosure is directed to a charge station placement (CSP) application that is configured to estimate an inferred charge station wireless communication signal strength or simply, an inferred charge station signal strength (ICSSS) for an electric vehicle charge station that is to be installed at a desired location. Specifically, the CSP application obtains a vehicle signal strength data indicative of signal strength of a wireless communication network in communication range of a vehicle, where the charge station is to employ the wireless communication network. Using use information associated with the vehicle that measured the signal strength (i.e., a measurement vehicle) and the charge station to be installed, the CSP application identifies/selects a surrogate vehicle-charge station pair from a surrogate information database that associates a plurality of surrogate charge stations with respective surrogate vehicles. That is, surrogate information provides information, such as signal strength measurements, of charge stations that are installed and operating, and of electric vehicles (EVs) that are associated with an installed charge station. Using the signal strength measurements and a signal strength surrogate model, which may be referred to as a signal surrogate model, the CSP application is configured to estimate the ICSSS for the charge station at one or more PIL and assess whether the ICSSS is acceptable for communication.

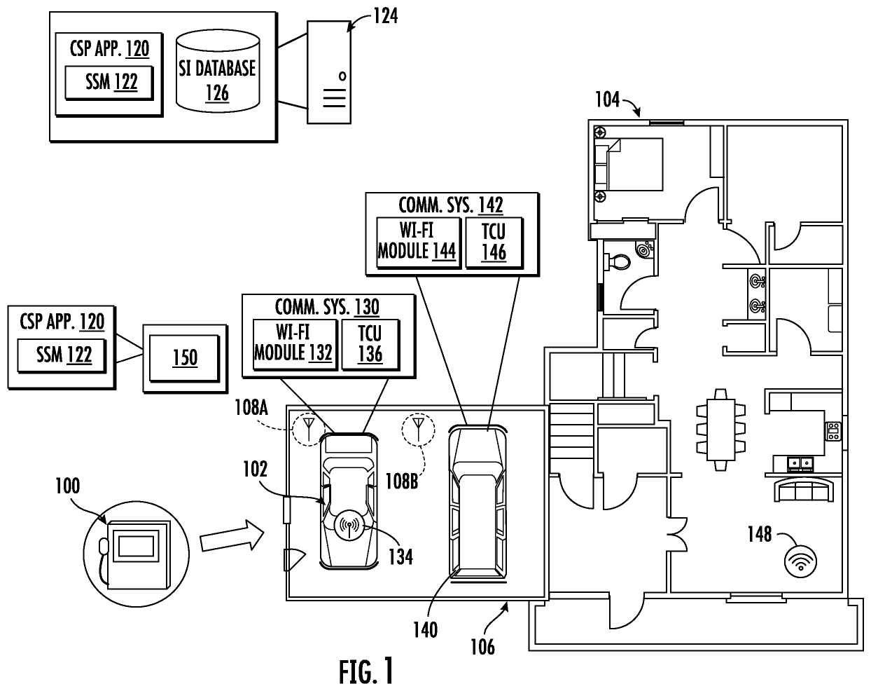

Referring to FIG. 1, a charge station 100 to be installed at a location is configured to charge an electric vehicle (EV) 102 using an electric power network associated the location. The charge station 100 is positioned to be near a desired area that the EV 102 is to be parked for a charge operation. In one form, the EV 102 may be a full-electric vehicle, a plug-in hybrid vehicle, or any other vehicle that can be recharged through plugging into the electrical grid. In a non-limiting example, FIG. 1 illustrates the charge station 100 that is to be installed at a house 104 and more specifically, inside, or outside of a garage 106 in which the EV 102 is to be parked. In FIG. 1, PIL 108 of the charge station 100 is illustrated as antenna.

The charge station 100 is further configured to wirelessly communicate with external devices/systems to communicate information, such as, but not limited to, a charge status, performance data, and routine test results. The charge station 100 may also receive over the air software updates from a remote server and/or be controlled by a tool that that transmits commands to the charge station 100 (e.g., portable computing device having a charge station software application). In one form, the charge station 100 establishes a wireless communication link using various communication techniques such as, but not limited to Wi-Fi, cellular, BLUETOOTH, and/or ultra-wideband (UWB). Specifically, the charge station 100 is configured to have a Wi-Fi module (not shown) with a Wi-Fi antenna (i.e., “charge station (CS) antenna”, herein), router, modem, to connect to a Wi-Fi network, such as a Wi-Fi network provided at the desired area (e.g., a home Wi-Fi network or local Wi-Fi network).

In one form, prior to installing the charge station 100, a charge station placement (CSP) application 120 of the present disclosure is configured to estimate an inferred charge station signal strength (ICSSS) for the charge station 100. Specifically, the CSP application 120 estimates the ICSSS using one or more Wi-Fi signal strength measurements detected by a vehicle at the desired area, such as the EV 102, and a signal surrogate model (i.e., a signal strength surrogate model) 122 that employs surrogate information including actual signal strength measurements of charge stations already installed and operating.

Specifically, in one form, a charge station support (CSS) server 124, which is a remote cloud-based server, is configured to obtain and store surrogate information in a surrogate information database (SI database) 126. In one form, the surrogate information includes information related to other charge stations (i.e., surrogate charge stations) that are installed at various locations that may be related or unrelated to the desired area (i.e., area that the new charge station 100 is to be installed at), and information related to other EVs (i.e., surrogate EV) that may employ the surrogate charge stations. The surrogate charge stations and the surrogate EVs routinely measure signal strength of a local Wi-Fi network (i.e., surrogate Wi-Fi network), and provide the signal strength measurements to the CSS server 124. Accordingly, the surrogate information associates surrogate charge stations with surrogate EV(s) and signal strength measurements. In a non-limiting example, information related to the surrogate charge station (SCS) includes a SCS identification, SCS model, SCS antenna type, and/or SCS signal strength data; information related to surrogate EV (SEV) includes a surrogate vehicle make/model, surrogate vehicle antenna type, surrogate vehicle signal strength data and/or surrogate vehicle position (e.g., GPS position) at the time signal measurements are taken. In some forms, the surrogate information may also include positional relationship between the surrogate charge station and the surrogate EV (e.g., distance between the surrogate charge station and the surrogate EV). In some forms, the surrogate EV may include multiple antennas, and thus, the surrogate information may include information related to the installation position of the antennas, which can be used to triangulate the direction of signal to understand signal degradation direction (i.e., where the signal is strongest and weakest relative to the surrogate EV and surrogate charge station).

With the surrogate information, the CSP application 120 is configured to identify a surrogate vehicle-surrogate charge station that correlates with the charge station 100 to be installed based on use information. Specifically, use information includes information related to the charge station 100 to be installed, the vehicle (e.g., EV 102) to be used to assist in estimating the ICSSS, and/or PIL 108 of the charge station 100. In a non-limiting example, the use information may include, but is not limited to: for the charge station 100, a charge station (CS) identification, CS model, and/or CS antenna type; for the vehicle, a vehicle make/model, vehicle antenna type, and/or vehicle position (e.g., GPS position) at the time signal measurements are taken; and/or position information (e.g., GPS position or location range) of the PIL 108 relative to the vehicle.

The CSP application 120 employs one or more Wi-Fi signal strength measurements of the local Wi-Fi network as a baseline signal strength at the desired area from a vehicle (i.e., a measurement vehicle) at the desired area, such as the EV 102. Specifically, the EV 102 includes a communication system 130 having a Wi-Fi module 132 with a Wi-Fi antenna 134 to connect to the local Wi-Fi network and, in some variations, to define a vehicle Wi-Fi network that is available to devices including the charge station 100 to connect to. In some variations, the EV 102 may also include a telematics control unit (TCU) 136 that is configured to support vehicle-to-anything communication (V2X) (i.e., vehicle-to-infrastructure, vehicle-to-vehicle, vehicle-to-cellular communications). The TCU 136 may include a global navigation satellite system (GNSS) antenna for obtaining locational information of the EV 102. While the vehicle providing the signal strength measurements is provided as the EV 102, it may also be a non-EV vehicle. For example, the vehicle providing a baseline signal measurement may be an internal combustion engine (ICE) vehicle 140 having a communication system 142. In a non-limiting example, the communication system 142 is similar to the communication system 130, and thus, includes a Wi-Fi module 144 and a TCU 146 that operate in a similar manner as Wi-Fi module 132 and TCU 136, respectively.

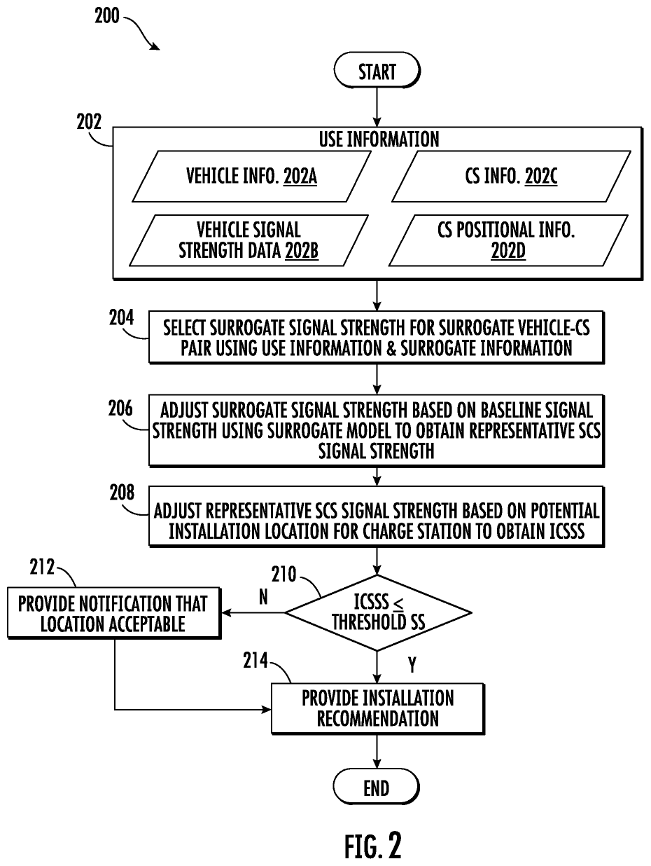

Referring to FIG. 2, an example charge station signal strength routine 200 for estimating an ICSSS and providing installation recommendation is provided and performed, at least in part by the CSP application 120.

At operation 202, the CSP application 120 is configured to obtain the use information, which includes vehicle information (Info.) 202A, vehicle signal strength data 202B, CS information (Info.) 202C, and/or CS positional information (Info.) 202D. As detailed above, the vehicle information 202A is information related to the vehicle providing the baseline signal strength for the local Wi-Fi network of the desired area. In a non-limiting example, this may include the EV 102, the ICE vehicle 140, or both the EV 102 and the ICE vehicle 140. The charge station information is related to the charge station 100 to be installed at the desired location. The CS positional information 202D provides positional information of the PIL 108 relative to the vehicle that provides the baseline signal strength, and thus, may include positional information for the EV 102 and the ICE vehicle 140.

In some forms, the vehicle may provide multiple signal strength measurements, where at least one of the signal strength measurements is taken at different environmental conditions than other signal strength measurements. That is, environmental conditions of the desired area and even the parking orientation of the vehicle may influence the signal strength measurement. For example, the signal strength detected on a clear day with no precipitation may be different from a measurement taken on a stormy day. In another example, referring to FIG. 1, if the vehicle is EV 102, and the EV 102 is backed into the garage 106, the Wi-Fi antenna 134 may be closer to an antenna 148 of the local Wi-Fi network than when the EV 102 is driven into the garage 106 with the front of the EV 102 facing a wall of the garage 106. Accordingly, the signal strength may be higher when the EV 102 is backed in vs. driven in front first. In a non-limiting example, the environmental conditions include at least one of time of day, day of the week, parking location of the vehicle, and/or weather.

In one form, with multiple signal strength inputs, the CSP application 120 is configured to aggregate the measurements to provide an average signal strength input. In another example, the CSP application 120 is configured to use the highest and lowest signal strength measurements to define the ICSSS.

Referring back to FIG. 2, at operation 204, the CSP application 120 selects a surrogate vehicle signal data of an identified surrogate vehicle associated with an identified surrogate charge station provided as part of the surrogate information using the use information. More particularly, the CSP application 120 is configured to analyze or filter through the surrogate information using the use information to find a relevant surrogate vehicle-charge station pair match. For example, the CSP application 120 identifies a surrogate vehicle that is similar to the vehicle that provided the baseline signal strength (e.g., at least one of same make, same model, same vehicle antenna, and/or having a positional relationship with an associated charge station that is same or within a defined threshold of the positional relationship in the use information). In another example, the CSP application 120 identifies a surrogate charge station that is similar to the charge station 100 to be installed (e.g., at least one of same model, same charge station antenna, having a positional relationship with an associated charge station that is same or within a defined threshold of the positional relationship in the use information).

In one form, if multiple surrogate vehicle-charge station pairs are identified, the CSP application 120 is configured to select from among the pairs using defined conditions that determine which surrogate vehicle-charge station pair is representative of the use information and more specifically, the charge station 100. For example, if a subject surrogate charge station has same information as that of the charge station 100, but the subject surrogate charge station is associated with a different type of vehicle, the CSP application 120 is configured to select the subject surrogate charge station and its associated vehicle as the surrogate vehicle-charge station pair over a surrogate vehicle-charge station pair in which the surrogate vehicle is the same as the EV 102, but has a different associated charge station that the charge station 100. In one form, the CSP application 120 is configured to score categories of the use information and provide a qualification score for each identified surrogate vehicle-charge station pair, and selects the pair with that highest score. For example, information regarding the charge station antenna may be allocated a higher score than charge station type.

Once a surrogate vehicle and surrogate charge station is identified, the CSP application 120 is configured to, via the signal surrogate model 122, estimate a representative SCS signal strength at a measurement location associated with the vehicle providing baseline signal strength data (e.g., EV 102 and/or ICE vehicle 140), at operation 206. Specifically, the signal surrogate model 122 obtains the surrogate vehicle signal strength data associated with the surrogate vehicle and the surrogate charge station signal strength data associated with the surrogate charge station. The signal strength model is configured to adjust the surrogate vehicle strength data to be the same as the signal strength data obtained from the vehicle, and adjust the surrogate charge station signal strength data based on the adjustment to the surrogate vehicle signal strength. Specifically, in one form, the signal surrogate model 122 is configured to use data correlating antenna-to-antenna variations, which includes operation difference between different antennas used in charge stations, between different antennas used in EVs, and/or between an antenna in a charge station and an antenna in an EV to adjust the surrogate signal strength measurements.

With the representative SCS signal strength, the CSP application 120 is configured to calculate the ICSSS for the PIL 108 for the charge station 100 based on a positional relationship of the EV 102 (and/or ICE vehicle 140) and the PIL 108, at operation 208. That is, the representative SCS signal strength is an estimated signal strength of the surrogate charge station at a location of, for example, the EV 102, and not at a PIL 108 of the charge station 100. Thus, the representative SCS signal strength is adjusted based on positional relationship (e.g., distance) between the location of the EV 102 and the PIL 108. In a non-limiting example, one or more signal algorithms that are configured to estimate a signal strength at a selected location based on signal strength value at a first location may be used. If multiple PIL 108 are given, the CSP application 120 is configured to provide an ICSSS for each potential installation location. In lieu of a specific location, if the PIL 108 is provided as a range (e.g., 5 ft from the EV 102), a range of ICSSS can be provided.

With the ICSSS, at operation 210, the CSP application 120 is configured to determine whether the ICSSS is less than or equal to a connectivity threshold that can be predefined and provided as the lowest acceptable signal strength for communicating via a Wi-Fi signal. If ICSSS is greater than the connectivity threshold than the PIL 108 is acceptable, and the CSP application 120 provides a notification to the user (e.g., displaying a message on screen of a computing device), at operation 212.

If the ICSSS is less than or equal to the connectivity threshold, then the CSP application 120 provides or outputs an installation recommendation, at operation 214. In a non-limiting example, the installation recommendation includes at least one of recommending a different installation location for the charge station 100 or a connectivity enhancement technique to increase signal strength. More specifically, the CSP application 120 may include a multi-tiered recommendation table that associates different recommendations based on different signal strength measurements/ranges. Accordingly, if the inferred charge station signal strength is close to or equal to zero, then the PIL 108 would not be appropriate, and the CSP application 120 outputs a notification indicating a different installation location is needed. In some applications, the CSP application 120 may provide an image indicating the ICSSS at the PIL108 and the representative SCS signal strength at the vehicle location to illustrate the different measurements. Alternatively, if the ICSSS can be improved with connectivity enhancement techniques, such as adding a Wi-Fi booster, the CSP application 120 outputs a notification providing such a recommendation.

In addition to the above, the following provides some additional examples of recommendations, which may be used individually or in combination with one another. In some variations, multiple recommendations may be associated with same signal strength measurement/range, where different options for improving the signal strength can be provided. In yet another variation, the recommendation may be provided as a series of steps/instructions to be performed by the user. The recommendations may be communicated in various suitable ways such as, but not limited to, displaying a blueprint map of the area, descriptive text, and/or an image of the area that may be augmented to include descriptive text/symbols to communicate the PIL 108 or signal strength. While specific examples of the recommendation are provided, other types of recommendations and/or methods of providing the recommendation may be used (e.g., presenting alternative PIL using a map and/or listing connectivity enhancement techniques with recommended devices to perform the enhancement).

The CSP application 120 may be implemented and accessible in various suitable ways. The following provides multiple example that may be implemented individually or in combination with one another. Other implementation of the CSP application 120 may also be within the scope of the present disclosure, and thus, should not be limited to the examples provided herein.

Referring back to FIG. 1, in a non-limiting example, the CSP application 120 is stored and executed by a computing device 150 (e.g., a tablet, laptop, smartphone) to estimate the ICSSS for the charge station 100. Using components of the computing device 150, such as communication system, the CSP application 120 is configured to communicate with the CSS server 124 to access the surrogate information, and provide a notification using a display and/or audio system of the computing device 150.

In another example, CSS server 124 is configured to have the CSP application 120, and may receive information from the user that is accessing the CSP application 120 via a web-based interface. In some variations, the EV 102 and/or the ICE vehicle 140 may communicate with server 124 to access the CSP application 120 and obtain the ICSSS. In a non-limiting example, an infotainment system of the vehicle may display graphical user interfaces provided by the CSP application 120 to exchange information with the user regarding the ICSSS requested.

The CSP application 120 of the present disclosure employs surrogate information of recorded signal strength data of EVs and of charge stations that are installed and in operation. The CSP application 120 estimates the ICSSS using measured signal strength data for identified Wi-Fi antennas and takes into consideration antenna-to-antenna performance.

As provided above, in one form, the CSP application 120 may be stored and executed by one computing device. In another form, aspects of the CSP application 120 may be stored and executed by multiple computing devices (e.g., portion may be provided on: the server 224 and the EV 102 and/or the ICE vehicle 140; the server 224 and computing device 150).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
estimating an inferred charge station wireless communication signal strength for a new electric vehicle supply equipment (EVSE) using signal strength data and a signal strength surrogate model, wherein:
the signal strength data is indicative of signal strength of a wireless communication network measured by a measurement vehicle, wherein the wireless communication network is to be in communication with the new EVSE, and
the signal strength surrogate model is configured to define one or more signal strengths using surrogate information associating a plurality of surrogate charge stations with respective surrogate vehicles, and signal strength data associated with, at least one of the surrogate charge stations or the surrogate vehicles; and
outputting an installation recommendation in response to the inferred charge station wireless communication signal strength being less than or equal to a connectivity threshold.

2. The method of claim 1, further comprising:
selecting, based on use information, a surrogate vehicle signal data of an identified surrogate vehicle associated with an identified surrogate charge station provided as part of the surrogate information, wherein:
the use information is associated with the measurement vehicle and the new EVSE, the use information including at least one of a vehicle make-model, a vehicle antenna type, a charge station type, and/or a charge station antenna type; and
at least one of a surrogate vehicle make-model, a surrogate vehicle antenna type, a surrogate charge station type, or a surrogate charge station antenna type is same as that of the use information.

3. The method of claim 2, wherein estimating the inferred charge station wireless communication signal strength for the new EVSE further comprises:
defining, by the signal strength surrogate model, a representative surrogate charge station signal strength at a measurement location associated with the measurement vehicle using a surrogate vehicle signal strength data as part of the surrogate information and the signal strength data measured by the measurement vehicle; and
calculating the inferred charge station wireless communication signal strength for at least one potential installation location for the new EVSE using the representative surrogate charge station signal strength, and a positional relationship of the measurement vehicle and the at least one potential installation location.

4. The method of claim 1, wherein the installation recommendation includes at least one of recommending a different installation location for the new EVSE or one or more connectivity enhancement to increase signal strength.

5. The method of claim 1, further comprising outputting a message confirming installation location for the new EVSE in response to the inferred charge station wireless communication signal strength being greater than the connectivity threshold.

6. The method of claim 1, wherein the surrogate information includes at least one of: a surrogate vehicle make-model, a surrogate vehicle antenna type, a surrogate vehicle signal strength data, a location information indicating positional relationship between a surrogate vehicle and a surrogate charge station associated with the surrogate vehicle, a surrogate charge station model, a surrogate charge station antenna type, or a surrogate charge station signal strength data.

7. The method of claim 1, wherein the signal strength data indicative of signal strength of the wireless communication network includes signal strength data for a plurality of signal strength measurements, wherein at least one of the signal strength measurements is taken at different environmental conditions than other signal strength measurements.

8. The method of claim 7, wherein the environmental conditions include at least one of time of day, day of week, parking location of the measurement vehicle, or weather.

9. A system comprising:
one or more computing devices configured to:
estimate an inferred charge station wireless communication signal strength for a new electric vehicle supply equipment (EVSE) using signal strength data and a signal strength surrogate model, wherein:
the signal strength data is indicative of signal strength of a wireless communication network measured by a measurement vehicle, wherein the wireless communication network is to be in communication with the new EVSE,
the signal strength surrogate model is configured to define one or more signal strengths using surrogate information associating a plurality of surrogate charge stations with respective surrogate vehicles, and signal strength data associated with, at least one of the surrogate charge stations or the surrogate vehicles; and
output an installation recommendation in response to the inferred charge station wireless communication signal strength being less than or equal to a connectivity threshold.

10. The system of claim 9, wherein the one or more computing devices is further configured to:
select, based on use information, a surrogate vehicle signal data of an identified surrogate vehicle associated with an identified surrogate charge station provided as part of the surrogate information, wherein:
the use information is associated with the measurement vehicle and the new EVSE, the use information including at least one of a vehicle make-model, a vehicle antenna type, a charge station type, and/or a charge station antenna type; and
at least one of a surrogate vehicle make-model, a surrogate vehicle antenna type, a surrogate charge station type, or a surrogate charge station antenna type is same as that of the use information.

11. The system of claim 10, wherein to estimate the inferred charge station wireless communication signal strength for the new EVSE, the one or more computing devices is further configured to:
define, by the signal strength surrogate model, a representative surrogate charge station signal strength at a measurement location associated with the measurement vehicle using a surrogate vehicle signal strength data as part of the surrogate information and the signal strength data measured by the measurement vehicle; and
calculate the inferred charge station wireless communication signal strength for at least one potential installation location for the new EVSE using the representative surrogate charge station signal strength, and a positional relationship of the measurement vehicle and the at least one potential installation location.

12. The system of claim 9, wherein the installation recommendation includes at least one of recommending a different installation location for the new EVSE or one or more connectivity enhancement to increase signal strength.

13. The system of claim 9, wherein the one or more computing devices is configured to output a message confirming installation location for the new EVSE in response to the inferred charge station wireless communication signal strength being greater than the connectivity threshold.

14. The system of claim 9, wherein the surrogate information includes at least one of: a surrogate vehicle make-model, a surrogate vehicle antenna type, a surrogate vehicle signal strength data, a location information indicating positional relationship between a surrogate vehicle and a surrogate charge station associated with the surrogate vehicle, a surrogate charge station type, a surrogate charge station antenna type, or a surrogate charge station signal strength data.

15. The system of claim 9, wherein the signal strength data indicative of signal strength of the wireless communication network includes signal strength data for a plurality of signal strength measurements, wherein at least one of the signal strength measurements is taken at different environmental conditions than other signal strength measurements.

16. The system of claim 15, wherein the environmental conditions include at least one of time of day, day of week, parking location of the measurement vehicle, or weather.

17. The system of claim 9, further comprising a database for storing the surrogate information.

18. A method comprising:
estimating an inferred charge station wireless communication signal strength for a new electric vehicle supply equipment (EVSE) using signal strength data and a signal strength surrogate model, wherein:
the signal strength data is indicative of a plurality of signal strength measurements of a wireless communication network measured by a measurement vehicle, wherein the wireless communication network is to be in communication with the new EVSE, and
the signal strength surrogate model is configured to define one or more signal strengths using surrogate information associating a plurality of surrogate charge stations with respective surrogate vehicles, and signal strength data associated with, at least one of the surrogate charge stations or the surrogate vehicles;
outputting a message confirming installation location for the new EVSE in response to the inferred charge station wireless communication signal strength being greater than a connectivity threshold; and
outputting an installation recommendation in response to the inferred charge station wireless communication signal strength being less than or equal to the connectivity threshold, the installation recommendation including at least one of recommending a different installation location for the new EVSE or one or more connectivity enhancement to increase signal strength.

19. The method of claim 18, further comprising:
selecting, based on use information, a surrogate vehicle signal data of an identified surrogate vehicle associated with an identified surrogate charge station provided as part of the surrogate information, wherein:
the use information is associated with the measurement vehicle and the new EVSE, the use information including at least one of a vehicle make-model, a vehicle antenna type, a charge station type, and/or a charge station antenna type;
the surrogate information includes at least one of: a surrogate vehicle make-model, a surrogate vehicle antenna type, a surrogate vehicle signal strength data, a surrogate charge station type, a surrogate charge station antenna type, or a surrogate charge station signal strength data; and
at least one of the surrogate vehicle make-model, the surrogate vehicle antenna type, the surrogate charge station type, or the surrogate charge station antenna type is same as the vehicle make-model, the vehicle antenna type, the charge station type, or the charge station antenna type of the use information, respectively.

20. The method of claim 18, wherein estimating the inferred charge station wireless communication signal strength for the new EVSE further comprises:
defining, by the signal strength surrogate model, a representative surrogate charge station signal strength at a measurement location associated with the measurement vehicle using a surrogate vehicle signal strength data as part of the surrogate information and the signal strength data measured by the measurement vehicle; and
calculating the inferred charge station wireless communication signal strength for at least one potential installation location for the new EVSE using the representative surrogate charge station signal strength, and a positional relationship of the measurement vehicle and the at least one potential installation location.
